(19) United States
(12) Patent Application Publication
(10) Pub. No.: US 2006/0143664 A1
(43) Pub. Date: Jun. 29, 2006

(54) Features for interactive media VCR-type control

(75) Inventors: William Hartselle, Norcross, GA (US); Dennis Meek, Norcross, GA (US); Gregory S. Smith, Dunwoody, GA (US); Robert J. Frohwein, Atlanta, GA (US)

Correspondence Address: BAMBI FAIVRE WALTERS, PO BOX 5743, WILLIAMSBURG, VA, 23188, US

(73) Assignee: BellSouth Intellectual Property Corporation

(21) Appl. No.: 11/022,740

(22) Filed: Dec. 27, 2004

(51) Int. Cl. H04N 7/173; H04N 7/16

(52) U.S. Cl. 725/88; 725/102; 725/135; 725/90

(57) ABSTRACT

An Interactive Media Control Module provides flexible subscriber VCR controls of and functions for an interactive media system that limit the consumption of bandwidth capacity. According to some of the embodiments, a reactivation function is provided when pause and rewind controls are deactivated in a viewing window such that the pause and rewind controls may be reactivated by ordering a bookmarked viewing window.

### CROSS REFERENCE TO RELATED APPLICATION

This application relates to applicants' co-pending application entitled “Features of VCR-Type Controls for Interactive Media,” (Attorney Docket BS040401) filed simultaneously herewith, incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments relate to the field of interactive media systems, and more particularly, to providing media delivery control services.

Interactive media system providers (e.g., providers offering satellite broadcast, digital cable, telephony and other media services) have long been offering services that permit subscribers to purchase movies or special events for in-home viewing to an interactive media system such as a set top box (STB) and a television (TV). These services enable a subscriber to browse a library of live and pre-recorded programs, to order a program, and to watch that program. Typical variations of these services include pay-per-view, near video-on-demand (NVOD), and video-on-demand (VOD). Pay-per-view services usually offer live broadcast events that are shown only once, such as Wrestlemania™ or boxing events. Near-video-on-demand services typically deploy continuous video streams at regular intervals (e.g., the same movie is shown for a whole day starting every fifteen minutes). Finally, video-on-demand services typically deliver individual media streams to subscribers immediately upon ordering. Overall, subscribers greatly value these services for their convenience in avoiding such difficulties as traveling to rent and return a video cassette or digital video disc (DVD) from a retail vendor; however, many of these available services are media intensive and demand high bandwidth.

To further attract subscribers to these interactive media services, service providers have added viewing functions that emulate the operation of a video cassette recorder (VCR). Examples of these VCR functions include pause, rewind, and fast-forward. In this manner, subscribers can order a program and not be constrained by a continuous, unstoppable showing. Instead, the enhanced service gives the subscribers control over the delivery of the program and increased viewing flexibility. For example, with VCR-like functions, a subscriber can pause the viewing of an ordered program to accommodate such interruptions as telephone calls or trips to bathroom. In addition, using the rewinding function, a subscriber can return to and replay a favorite movie scene or perhaps return to a critical point in a program to ascertain missed information. Thus, subscribers have come to appreciate interactive media services with VCR-like control and will pay a premium to use them.

As used herein, “VCR-like control” and “VCR control” are synonymous terms describing the simulated video cassette recorder control that is applied to interactive media services. Likewise, “VCR function” refers to a simulated video cassette recorder function, such as pause.

Although giving subscribers more viewing control increases subscribership and revenues, the added control presents a significant bandwidth problem for the service providers. Specifically, with unlimited VCR control, a subscriber can continuously use available bandwidth by, for example, watching a program or a portion of a program several times using the rewind function. Or, a subscriber might activate the pause feature for an extended amount of time and return to the program hours or days later. In effect, a subscriber with unlimited VCR control can consume the bandwidth allotted to his program for an indefinite amount of time. Further, for every subscriber tying up a portion of bandwidth, the capacity of the video server providing the service is reduced, resulting in, at some point, the service provider's inability to sell another program to another subscriber.

To offset this bandwidth consumption, one method of limiting VCR control invokes a “time out” function that terminates a subscriber's ability to play the program. Typically, service providers have experimented with weekly or daily purchases, where a subscriber can view the program and use the VCR control without restriction during the allotted time period. However, service providers still find subscribers exploiting the service by watching a program repeatedly and consuming the allotted bandwidth for nearly the whole purchase period. Although the service providers can compensate for this repeated viewing by charging more for the service, subscribers tend to forego the service as cost increases.

To further limit the VCR control, service providers sometimes reduce purchase periods from weekly or daily durations to durations of a few hours. This time limit restricts the number of times a subscriber can rewind and replay a program, and simplifies the tasks of allocating bandwidth and opening capacity to other subscribers. However, timing out after just a few hours greatly reduces viewing flexibility and frustrates subscribers. As an example of this inflexible time out feature, a subscriber given five hours to watch a two hour movie might unexpectedly have to pause the program to take an important and lengthy telephone call. Even upon returning to the program within the five hours, the subscriber may not have enough time to watch the end of the movie because the remaining duration of the movie exceeds the time remaining before the time out. The result in these prior art time out systems is the termination of the movie, without warning and regardless of whether the subscriber reached the end of the movie. In addition, this time out method imposes a fixed viewing period that fails to factor in the length of a particular ordered program. Thus, a subscriber may think he has the same grace period for a longer program as for a shorter program, only to be cut off at the end of the viewing period.

Instead of timing out, some service providers base a completed program purchase on whether the subscriber views the end of the program. For example, the service provider can deactivate the VCR control once the subscriber reaches a certain point toward the end of the program, such as the rolling of credits. However, clever subscribers aware of the threshold point can still rewind, pause, and replay as often as they like and consume bandwidth to the detriment of the service provider. In addition, determining the point in a program at which to deactivate the VCR control is a tricky exercise, which can result in service behavior that annoys some subscribers but not others. For example, some subscribers may want the ability to rewind during the credits to catch an actor's name while others simply turn off the program when credits begin.

Rather than limiting viewing time, some service providers restrict the total time that the VCR control can be applied. For example, a service provider may limit a subscriber to pressing the pause, rewind, or fast-forward functions for a total of 10 minutes. Pressing pause for 10 minutes is straightforward and is not problematic. However, in typical interactive media systems with VCR control, pressing rewind or fast-forward a certain amount of time shifts the viewing time a proportionally longer amount of time (e.g., in a system in which rewind and fast-forward speeds are 8 times faster than the viewing time speed), pushing the rewind or fast-forward button for 10 minutes backs up or advances the real time running of the program 80 minutes. Thus, following this example, for a movie or program shorter than 80 minutes, the subscriber could essentially rewind the whole program and watch it again, increasing the bandwidth consumption up to 80 minutes.

As another disadvantage, the interactive media systems that limit the duration of VCR control fail to credit a subscriber for pressing fast-forward and for actually reducing the bandwidth consumption. For instance, with VCR control limited to 10 minutes, if the subscriber pressed the fast-forward button for 10 minutes to check the name of an actor in the credits appearing 80 minutes later in the running time of the program, the subscriber would consume all 10 minutes of the VCR control. Further, because the interactive media systems that limit VCR control fail to recognize that pressing fast-forward reduces bandwidth and fail to credit the subscriber with the reduced bandwidth, the subscriber would have no more (credited) time for VCR control and would be unable to rewind to the original program location. (If the subscriber were to rewind to the original program location, the net change in bandwidth consumption would only be the sum of the 10 minutes it took to press fast-forward, the minute or so it took to read the credits, and the approximately 10 minutes it took to return to the original program location.)

Similarly, these interactive media systems fail to allow a subscriber to freely rewind and fast-forward to review prior segments and return to previous viewing locations. For instance, with VCR control limited to 10 minutes, if a subscriber backed up 80 minutes in a program to replay a favorite scene, the subscriber could not fast-forward to the previous viewing time to resume watching the rest of the program. Instead, after backing up 80 minutes and using 10 minutes of rewind/pause/fast-forward time, the subscriber would have to wait 80 minutes of real-time viewing to return to the location from which the subscriber began rewinding.

Alternatively, instead of limiting the amount of time a subscriber can rewind or fast-forward, a service provider can limit the amount of time traversed in the program's running time. For instance, the service provider would limit the amount of time traversed in the program's running time to 10 minutes, rather than limiting the pause/rewind/fast-forward time to 10 minutes. However, based on the 1:8 ratio, this limit would leave the subscriber with only 1.25 minutes of VCR control—hardly enough to satisfy subscribers and encourage interactive media purchases.

### SUMMARY

The exemplary embodiments include methods, systems, computer programs, and/or computer program products for providing flexible subscriber control of an interactive media session without unnecessarily consuming bandwidth capacity. According to some of the embodiments, media delivery control services establish a viewing time window in which a subscriber can watch an ordered program, enable the subscriber to freely pause, rewind, and fast-forward the program so long as the end of the program does not exceed the end of the window, automatically track the remaining program running time against the time remaining in the window, deactivate the pause and rewind features if the remaining program running time equals the time remaining in the window, reactivate the pause and rewind features if the program is fast-forwarded such that the time remaining in the window exceeds the remaining program running time, and display a post-deactivation status that indicates that the pause function and the rewind function are no longer operable because the remaining program time is equal to or greater than the remaining viewing time. The post-deactivation status is presented to a display device of the interactive media system subsequent to the deactivation of the pause function and the rewind function. According to further embodiments, the media delivery control services may also display a re-activation prompt that functions to re-activate the pause function and the rewind function for a subsequent fixed duration when the remaining program running time equals or is less than the time remaining in the window (e.g., when the VCR controls are deactivated in the program). And, still further exemplary embodiments of this invention include displaying a post viewing time status that summarizes an end time of the viewing time window, identifies a bookmark in the program when the remaining program running time equals or is less than the time remaining in the window (e.g., when the VCR controls are deactivated), or, alternatively when the window ends with remaining program time. The post viewing time status function further presents an activation code that provides a bookmarked viewing window for viewing the program from the bookmark to an end of the program. If the subscriber activates the bookmarked viewing window, then VCR control of bookmarked interactive media programs is provided to the subscriber with reasonable limitations to conserve the bandwidth resources of service providers. Thus, subscribers receive a quality media delivery service that fulfills their requirement for VCR functionality, while the service providers conserve system resources, enlist more subscribers, and maximize profits.

According to some embodiments for providing the bookmarked viewing window, the program is bookmarked with a bookmark when the remaining viewing time window equals or is less than the remaining program time of the program, calculates a bookmarked program time of a program from a bookmarked time to an ending time of the program, establishes the bookmarked viewing time window that is equal to or greater than the bookmarked program time, plays the program from approximately the bookmark, provides a pause function and a rewind function, calculates a remaining bookmarked viewing time of the bookmarked viewing time window and a remaining bookmarked program time, and/or activates the pause function and the rewind function when the remaining bookmarked program time is less than the remaining bookmarked viewing time. According to further exemplary embodiments for providing the bookmarked viewing window, this invention may deactivate the pause function and the rewind function when the remaining bookmarked program time is equal to or greater than the remaining bookmarked viewing time.

The exemplary embodiments are implemented in any interactive media system that delivers video streams. Generally, the interactive media system includes a data storage device of finite capacity (e.g., a video server (or alternate program source) that stores video data and communicates that video data in video streams). According to some embodiments, the video streams are prerecorded programs; however, the video streams may also include live or near-real time programs, such as, for example, sporting events, news reports, and live gaming. In exemplary embodiments, the interactive media system is an interactive television system that supports services such as, for example,

pay-per-view, video-on-demand, and gaming. However, in other exemplary embodiments of this invention, the interactive media system is an internet-based interactive media system, in which video streams are downloaded through the internet and played at a subscriber's personal computer, communications device, and/or other display device.

According to some embodiments, this invention establishes the length of the bookmarked viewing time window based on a selected multiple of a remaining program time when a remaining viewing window equals or is greater than a remaining program time, the selected multiple approximately greater than 1, and more particularly, between approximately 1.5 and 2. For example, with a multiplier of 1.5, if a movie with a program running time of two hours is played for an hour and twenty minutes, such that forty minutes remain to an end time of the movie, then the bookmarked viewing time window is 1.5 times forty minutes, or one hour. During this hour, the subscriber may pause, rewind, or fast-forward, subject to the limitation that the remaining movie must end within the hour bookmarked viewing time window. Using a multiplier carries the advantage of accounting for the length of the remaining program instead of imposing inflexible cut-off times like those of the prior art. Thus, a subscriber has a proportionally equal grace period for both short and long programs and is not short-changed on VCR control when viewing longer remaining programs. In addition, different multipliers could be applied to programs of different lengths and to programs of different types (e.g., a longer remaining program time of two or more hours could have a multiplier of 2 while a short remaining program time could have a multiplier of 1.5, a live sporting event program such as a football game could have a multiplier of 2 while recorded TV show (NBC's “Friends”) could have a multiplier of 1.5, and so on).

Once an appropriate multiplier is determined, the remaining bookmarked program time is continually tracked against the time remaining in the bookmarked viewing time window. Further, some of the embodiments of this invention report the status of the remaining bookmarked program time and remaining bookmarked viewing window time to the subscriber. In further exemplary embodiments, when the remaining bookmarked program time is equal to or greater than the remaining bookmarked viewing window, this invention provides a post deactivation prompt that allows the subscriber to purchase a finite amount of additional time to add to and extend the remaining bookmarked viewing window, and, consequently, to re-activate VCR control of pause and rewind.

Other systems, methods, and/or computer program products according to the exemplary embodiments will be or become apparent to one with skill in the art upon review of the following drawings and detailed description. It is intended that all such additional systems, methods, and/or computer program products be included within and protected by this description and be within the scope of this invention.

### DESCRIPTION OF THE DRAWINGS

The above and other embodiments, objects, uses, advantages, and novel features are more clearly understood by reference to the following description taken in connection with the accompanying figures, wherein:

FIG. 1 illustrates a block diagram of exemplary details of a multimedia device according to some of the embodiments of this invention;

FIG. 2 illustrates an exemplary operating environment for an interactive media delivery system according to some of the embodiments of this invention;

FIG. 3 is a bar diagram illustrating sequentially applied VCR commands to the playing of a movie within a viewing time window and a bookmarked viewing time window according to some of the embodiments of this invention;

FIG. 4 is a table listing the viewing time, program time, grace period, bookmarked viewing time, bookmarked program time, and other values for each time bar shown in FIG. 3;

FIG. 5 illustrates another exemplary operating environment for an interactive media delivery system according to some of the embodiments of this invention; and

FIG. 6 illustrates yet another exemplary operating environment for an interactive media delivery system according to some of the embodiments of this invention.

### DETAILED DESCRIPTION

The exemplary embodiments now will be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

The exemplary embodiments include methods, systems, computer programs, and/or computer program products for providing an interactive media system with VCR control that limits a subscriber's bandwidth consumption yet provides a flexible and satisfactory viewing experience akin to home video viewing. The exemplary embodiments of the media delivery control services enhance any interactive media delivery system, including, for example, conventional cable television networks, wireless cable television networks, home satellite television networks, internet-based video stream delivery systems, hard disk download systems (in which multimedia content is downloaded and viewed from a local hard disk for a limited amount of time—e.g., TiVo™ interactive television systems), “dumb terminal” systems (in which a head end possesses the intelligence and a device, such as a set-top box, passes key stroke information to the head end), and other media delivery systems that allow duplex communication (perhaps with the return path via a separate telephony network) to a set-top box coupled to a subscriber's display device, such as a television. To initiate the delivery of multimedia content (also referred to herein as a “program”) for viewing to the interactive media system, the subscriber may access or otherwise interface with a service provider to select the program and establish a communications connection to deliver the selected program by actuating one or more pushbutton keys on a control device (e.g., a remote control, an interactive media terminal input device, and others) of the interactive media system. As used herein, the term “program” includes any electronic information, such as, for example video, text, audio, and/or voice in a variety of formats, such as dual tone multi-frequency, digital, analog, and/or others. Additionally, the term “program” may include: (1) executable programs, such as a software application, (2) an address, location, and/or other identifier of the storage location for the multimedia content or program, and (3) integrated or otherwise combined electronic files, such as a grouping of an entertainment program, an advertisement program, a billing program, and/or others. Typically, the program is then delivered to a communications address that may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

According to some exemplary embodiments, a viewing time window is established in which a subscriber can watch the ordered program, enables the subscriber to freely pause, rewind, and fast-forward the program so long as an end of the program does not exceed an end of the viewing time window, automatically tracks the remaining program running time against the time remaining in the window, deactivates the pause and rewind features if the remaining program running time equals the time remaining in the window, reactivates the pause and rewind features if the program is fast-forwarded such that the time remaining in the window exceeds the remaining program running time, and displays a post-deactivation status that indicates that the pause function and the rewind function are no longer operable because the remaining program time is equal to or greater than the remaining viewing time. This post-deactivation status is presented to a display device of the interactive media system subsequent to the deactivation of the pause function and the rewind function. According to further exemplary embodiments, this invention may also display a re-activation prompt that functions to re-activate the pause function and the rewind function for a subsequent fixed duration when the remaining program running time equals or is less than the time remaining in the window (e.g., when the VCR controls are deactivated in the program). And, still further exemplary embodiments of this invention include displaying a post viewing time status that summarizes an end time of the viewing time window, identifies a bookmark in the program when the remaining program running time equals or is less than the time remaining in the window (e.g., when the VCR controls are deactivated), or, alternatively when the window ends with remaining program time. The post viewing time status function further presents an activation code that provides a bookmarked viewing window for viewing the program from the bookmark to an end of the program. If the subscriber activates the bookmarked viewing window, then the subscriber may be provided with VCR control of bookmarked interactive media programs, yet reasonably limits that control to conserve the bandwidth resources of service providers. Thus, subscribers receive a quality media delivery service that fulfills their requirement for VCR functionality, while the service providers conserve system resources, enlist more subscribers, and maximize profits.

According to some embodiments for providing the bookmarked viewing window, the program is bookmarked with a bookmark when the remaining viewing time window equals or is less than the remaining program time of the program, calculates a bookmarked program time of a program from a bookmarked time to an ending time of the program, establishes the bookmarked viewing time window that is equal to or greater than the bookmarked program time, plays the program from approximately the bookmark, provides a pause function and a rewind function, calculates a remaining bookmarked viewing time of the bookmarked viewing time window and a remaining bookmarked program time, and activates the pause function and the rewind function when the remaining bookmarked program time is less than the remaining bookmarked viewing time. According to further exemplary embodiments for providing the bookmarked viewing window, the pause function and the rewind function may be deactivated when the remaining bookmarked program time is equal to or greater than the remaining bookmarked viewing time.

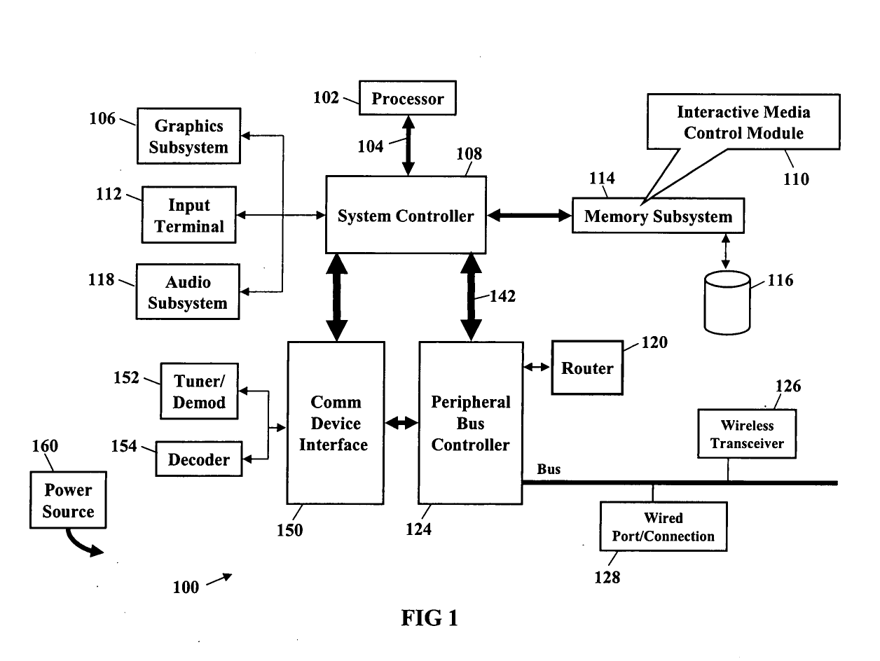

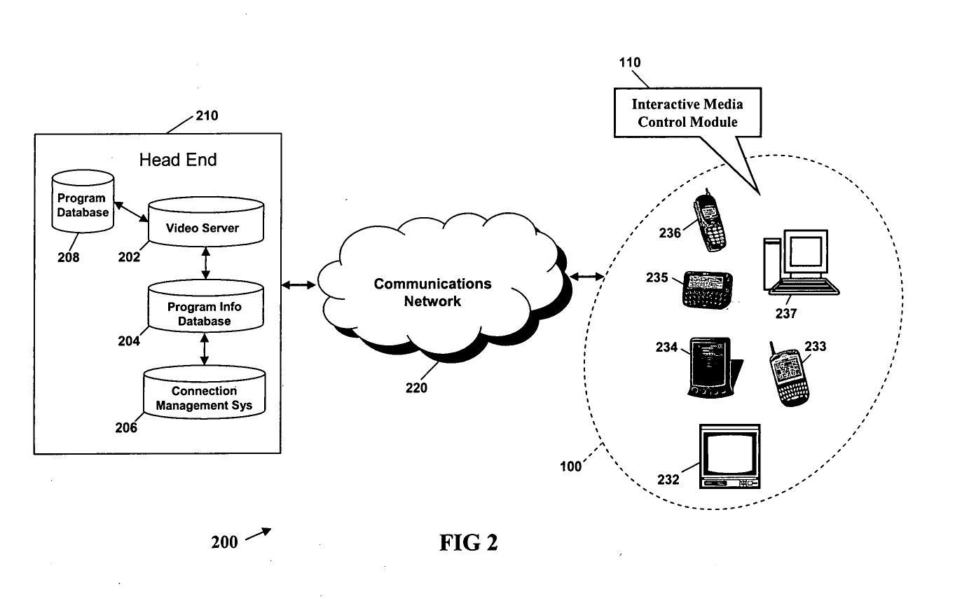

Referring now to the figures, FIG. 1 is a block diagram showing an Interactive Media Control Module 110 residing in a computer system shown as a multimedia device 100. As FIG. 1 shows, the Interactive Media Control Module 110 operates within a system memory device. The Interactive Media Control Module 110, for example, is shown residing in a memory subsystem 114. The Interactive Media Control Module 110, however, could also reside in flash memory or a peripheral storage device 116. The multimedia device 100 also has one or more central processors 102 executing an operating system. As one skilled in the art would appreciate, the operating system has a set of instructions that control the internal functions of the multimedia device 100, and furthermore has the capability to communicate a communications signal among the multimedia device 100, a communications network (e.g., reference numeral 210 in FIG. 2), and/or a connected electronic device capable of communicating audio, graphical, and/or other sensory data (e.g., a TV connected with the multimedia device 100, a wireless transceiver in an electronic device such as a remote control device, an appliance, a communications device, and/or other devices).

The system controller 108 provides a bridging function between the one or more central processors 102, a video/graphics subsystem 106, an input terminal 112, and an audio subsystem 118, the memory subsystem 114, a PCI (Peripheral Controller Interface) bus, and a Communications (“Comm”) Device Interface 150. The PCI bus is controlled by a Peripheral Bus Controller 124. The Peripheral Bus Controller 124 (typically called a “Southbridge”) is an integrated circuit that serves as an input/output hub for various peripheral ports and/or transceivers. The Peripheral Bus Controller 124 allows for communications with the communications network and any connected electronic device. The peripheral ports allow the multimedia device 100 to communicate with a variety of devices through networking ports (such as SCSI or Ethernet, not shown) and/or transceivers that include Wireless Communications (“Comm”) Device Transceiver 126 (for communication of any frequency signal in the electromagnetic spectrum, such as, for example, Wireless 802.11 and Infrared) and Wired Communications (“Comm”) Device Port/Connection 124 (such as modem V90+ and compact flash slots). These peripheral ports could also include other networking ports, such as, a serial port (not shown) and/or a parallel port (not shown). Further, a tuner/demodulator 152 may receive encoded digital signals (e.g., signals from a satellite receiver, a cable feed, and so on). The digital signals are divided into audio and video signals. The tuner/demodulator 152 tunes to the frequency of a broadcast media stream that is selected by the user. The tuner/demodulator 152 feeds the digital signals into a decoder 154 (either directly or via the Communications Device Interface 150). The tuner/demodulator tunes to the frequency of a selected decoder transport stream that is then decoded and fed to the graphics and audio subsystems 106, 118, such as A/V out jacks to a TV. Further, the multimedia device 100 may include a power source 160, such as a power cord that plugs into an electrical socket, a rechargeable battery to provide power and allow the media deliver device 100 to be portable, and/or others. Additionally, those of ordinary skill in the art understand that the program, processes, methods, and systems described in this patent are not limited to any particular computer system or computer hardware.

Those of ordinary skill in the art also understand the central processor 102 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular central processor of a manufacturer.

The operating system may be a UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems may include a WINDOWS-based operating system (WINDOWS® is a registered trademark of Microsoft Corporation, One Microsoft Way, Redmond Wash. 98052-6399, 425.882.8080, www.Microsoft.com) and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

According to an embodiment, programming subscription memory in the memory subsystem 114 operates with the processor 102 to maintain a list of television stations (or other multimedia delivery mediums) that are available to the viewer in accordance with a subscription plan. In order to select a channel, the processor 102 either receives signals from the input terminal 112, the wireless transceiver 126, and/or a device coupled or otherwise connected with the wired port/connection 128. Further, the system memory device may also contain an application program that cooperates with the operating system and with other input/output devices (e.g., the graphics subsystem 106, the input terminal 112, and/or the audio subsystem 118) to provide a graphical user interface (GUI). The graphical user interface provides a convenient visual and/or audible interface with the multimedia device 100. For example, the Interactive Media Control Module 110 provides a GUI that enables the user to access, select, order, and distribute multimedia content (e.g., the program), to provide VCR controls of the program, and to provide other menu options, such as, for example, status information, post viewing time status information and functions, post deactivation information and functions, and re-activation functions to quickly access, view, and/or activate VCR controls of a previously ordered program from a bookmark in the program.

As shown in FIG. 2, an interactive media delivery operating environment 200 includes a communications connection among the multimedia device 100 having the Interactive Media Control Module 110 and a head end 210 via a communications network 220. According to the exemplary embodiments of FIG. 2, the Interactive Media Control Module 110 establishes the communications connection among the multimedia device 100 and a communications address of the head end 210. The multimedia device 100 can be any device, such as an analog/digital recorder, television, CD/DVD player/recorder, audio equipment, receiver, tuner, and/or any other consumer multimedia device 100. The multimedia device 100 may also include any computer, peripheral device, camera, modem, storage device, telephone, personal digital assistant, and/or mobile phone. FIG. 2 illustrates exemplary multimedia devices that include a set top box coupled with a television 232, a Voice over Internet Protocol (VoIP) phone 233, a personal digital assistant 234, an interactive pager 235, and a cellular phone 236. The communications network 220 may be a television/cable network operating in the radio-frequency domain and/or the Internet Protocol (IP) domain. The communications network 220, however, may also include a distributed computing network, such as the Internet (sometimes alternatively known as the “World Wide Web”), an intranet, a satellite network, a telecommunications network (e.g., Public Switched Telephone Network, Mobile Switching Telephone Office, and others), a local-area network (LAN), and/or a wide-area network (WAN). The communications network 220 may include coaxial cables, copper wires, fiber optic lines, and/or hybrid-coaxial lines. The communications network 220 may even include wireless portions utilizing any portion of the electromagnetic spectrum and any signaling standard (such as the I.E.E.E. 802 family of standards). The communications address of the head end (or alternate delivery source of the program) may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

Within head end 210, a video server 202, a program information database 206, a connection management system 206, and a program database 208 provide the functions and information resources embodied in head end 210. That is, video server 202 receives from the multimedia device 100 subscriber viewing selections, retrieves programs from program database 208 based on the viewing selections, transmits a particular selected program on a particular channel or stream to a particular multimedia device 100, and instructs the particular multimedia device 100 to tune to the particular channel or select the particular stream. Video server 202 is in communication with program database 208, which stores and downloads video data files. Alternatively, video server 202 and program database 208 could be combined into a single component. The video data can be in any form compatible with the networked media delivery system (e.g., digitally encoded MPEG files). The content of the video data can be any media program (e.g., advertisements, television shows, news, movie trailers, movies, sporting events, and/or others).

Program information database 204 supplies program data such as title, actors, duration (running time), and perhaps the multiplier for the program (or for the interactive media system, if all programs use the same multiplier). Program information database 204 provides the multimedia device 100 with some ordinary information (e.g., a summary of the movie plot, information about actors, directors, and other information) that is presented to a display device of the multimedia device 100. In addition, program information database 204 provides the multimedia device 100 with the program duration, multiplier, bookmark, and/or bookmark viewing window multiplier required to calculate the viewing time window, to calculate and track the remaining viewing time and remaining program time, to calculate the bookmark viewing time window, to calculate and track the remaining bookmark viewing time and remaining bookmark program time, and/or to calculate supplemental fixed smart time information. Alternatively, the multimedia device 100 may be hard-coded with the multiplier and the bookmark viewing window multiplier, and, optionally, use a static supplemental multiplier to calculate the supplemental fixed smart time.

Connection management system 206 may be a packet switch device, a conditional access type device, or a combination of a packet switch device and a conditional access type device. Connection management system 206 establishes, monitors, and tears down client-server communications, including connecting individual multimedia device 100 through particular channels to head end 210. Generally, connection management system 206 assigns a video stream to a channel or other address and informs the subscriber's multimedia device 100 of the channel or address on which the program is running. Connection management system 206 also activates or deactivates streams on the video server and manages the connection and messaging (e.g., TCP/IP, between the multimedia device 100 and head end 210). In addition, connection management system 206 monitors the connection between the media deliver device 100 and video server 202 and shuts down a stream from video server 202 if the connection is lost for an extended period (e.g., if the multimedia device 100 loses power). Finally, connection management system 206 also executes the absolute shutting down of the video server stream at the end of the bookmarked viewing time window, the original viewing time window if supplemental fixed smart time is not activated or otherwise ordered to extend the viewing time window, or the extended viewing time window if supplemental fixed smart time is activated.

According to an exemplary embodiment, the multimedia device 100 resides at a subscriber's premise and may be integrated or otherwise connected to a display device (e.g., television). According to one embodiment, the multimedia device 100 is shown as a set-top box 232 that is sometimes referred to as a set-top terminal, a cable converter, or a home communications terminal. One or more of these terms apply generally to processing devices that are coupled to or made a part of a display device that shows programming to a subscriber. While the term “subscriber” is used throughout this description, it should be appreciated that the media services described herein may also be provided to a user of a multimedia device, (e.g., a person within the subscriber's household, whether or not the user is the actual subscriber to the media services).

Regardless of the type of multimedia device 100, each media deliver device 100 provides a control interface (e.g., the Interactive Media Control Module 110) that enables the subscriber to make viewing selections (e.g., using a remote control unit or an input terminal). In providing this interface, the multimedia device 100 performs the following functions: (1) routes traditional broadcast signals to the display device; (2) converts media content to a selected video format (e.g., NTSC or PAL) and presents the content; (3) for interactive systems, exchanges messages (including video data) with head end 210 over communications network 220; (4) receives messages from an input device, such as a remote control unit or a input terminal; (5) translates video signals from a network-native format into a format that can be presented to the display device; (6) inserts alphanumeric or graphical information into the video stream to overlay that information on the video image; and (7) provides graphic or audio feedback to the multimedia device. Examples of a commercially available multimedia device 100 that satisfy these functions include an SA Explorer 2000 set-top box by Scientific Atlanta, a DCT-5000 set-top box by General Instruments, and a Z12C set-top box by Zenith. Those of ordinary skill in the art will recognize other products and different types of products that may be used as the multimedia device 100.

According to exemplary embodiments, each multimedia device 100 completes many intelligent functions, including the receiving, storage, exchange, presentation of, and/or control of media content (e.g., the program and/or other data). To facilitate these functions, the Interactive Media Control Module 110 generates menu screens and accepts viewer menu selections, such as, for example, program orders, preview orders, requests to watch an advertisement, and relevant status information. Based on these selections, the Interactive Media Control Module 110 directs the video server to deliver the selected program (e.g., the server communicates the video stream of the selected program). In addition, the Interactive Media Control Module 110 receives relevant data from head end 210 (e.g., program duration) and continually executes one or more algorithms that receive or calculate the viewing time window, track the remaining viewing time window against the remaining program time, bookmark or confirm a bookmark when the remaining viewing time window is equal to or less than the remaining program time, calculate the bookmark viewing time window, track the remaining bookmark viewing time window and the remaining bookmark program time, calculate a supplemental fixed smart time to extend either the remaining viewing window or the remaining bookmark viewing window, and provide relevant status information and VCR control functionality.

Operating together, the above-described components provide interactive media VCR control. Once a subscriber has ordered a program through the multimedia device 100, connection management system 206 of head end 210 retrieves the ordered program from program database 208 and specifies a channel through which video server 202 is to transmit the program to the multimedia device 100. Connection management system 206 establishes the specified channel and manages the messaging and the connection (e.g., TCP/IP) between the media deliver device 100 and the video server 202. At the same time, the video server 202 instructs the Interactive Media Control Module 110 of the subscriber's set-top box to tune to the specified channel. Also, program information database 204 downloads the program duration and other relevant data to the Interactive Media Control Module 110. Optionally, the Interactive Media Control Module 110 could reside in head end 210, in which case the multimedia device 100 would merely transmit key presses (e.g., order program, pause, rewind, fast forward, re-activate VCR control functions, order bookmarked program, and so on) to head end 210, and the Interactive Media Control Module 110 at head end 210 would take the appropriate actions.

As video server 202 transmits the program through the specified channel, the subscriber may initiate VCR control via a remote control unit or other input terminal in communication with the multimedia device 100. When the multimedia device 100 receives a VCR command (e.g., pause, rewind, or fast-forward), the multimedia device 100 relays the command to the video server 202. Video server 202 then shuttles the video data in accordance with the subscriber's VCR command.

While the multimedia device 100 is receiving the VCR command, the Interactive Media Control Module 110 is continually and instantaneously calculating (1) the time remaining in the viewing time window, (2) the remaining duration of the program, (3) a bookmark when the remaining viewing time is equal to or less than the remaining program time, (4) the time remaining in the bookmark viewing time window, (5) the remaining bookmark duration of the bookmarked program (e.g., from the bookmark to an end of the program), and (6) a supplemental fixed smart time to extend the remaining viewing window or the remaining bookmark viewing window. According to some of the embodiments, the Interactive Media Control Module 110 (1) deactivates the pause and rewind functions (i.e., it no longer relays these commands to video server 202) when the remaining viewing time equals or is less than the remaining program time, (2) bookmarks the program and calculates a bookmarked viewing window in which the remaining program may be presented with pause and rewind function re-activated, (3) presents a deactivation status during presentation of the remaining program when the remaining viewing time is equal to or less than the remaining program time, the deactivation status includes displays an message that pause and rewind are deactivated, a bookmark of the program, and a prompt to order the bookmarked viewing window for viewing the program from the bookmark to an end of the program, (4) if the bookmarked viewing window is ordered, continues presentment of the program and re-activates the pause and rewind function so long as the remaining bookmark viewing time is equal to or less than the remaining bookmark program time, (5) presents a re-activation function to re-activate the pause and rewind function using a supplemental smart fixed time to extend the remaining viewing time or the remaining bookmark viewing time, (6) if re-activation is ordered, re-activates the pause and the rewind function according to the supplemental smart fixed time, and (7) when the remaining viewing time or the remaining bookmarked viewing time is zero (no viewing time remaining), presents a post viewing time function that displays an end time of the window, a bookmark of the program at the end time of the window, and a prompt to order the bookmarked viewing window for viewing the program from the bookmark to an end of the program.

If the subscriber subsequently fast-forwards the program, the Interactive Media Control Module 110 runs the calculations again and may (1) recognize that the time remaining in the viewing time window exceeds the remaining program time, and reactivate the pause and rewind VCR functions or (2) recognize that the time remaining in the bookmark viewing time window exceeds the remaining bookmark program time, and reactivate the pause and rewind VCR functions. This calculation-deactivation-reactivation process continues until there is no time remaining in the viewing time window, or the bookmark viewing time window, and the program has reached its end. Once the program is complete, connection management system 206 tears down the channel between video server 202 and the multimedia device 100 to free the system resources for other purchased programs.

To track whether VCR functions can be activated, deactivated, and/or re-activated, exemplary embodiments of this invention continually track the remaining program running time against the time remaining in the viewing time window and the remaining bookmark program running time against the time remaining in the bookmark viewing time window. To calculate the time remaining in the window (either the viewing time window or the bookmark viewing time window), the elapsed viewing time is subtracted from the total time of the window. The remaining program running time and the remaining bookmark program running time are calculated using either an end time method or a time stamp method. The end time method is preferred for interactive media systems that do not provide program time stamps while the time stamp method is preferred for those systems that do provide program time stamps. Further, the time stamp method provides advantages over the end time method in the following circumstances: 1) when an interactive media system does not provide a consistent ratio of rewind/fast-forward time to viewing time because of, for example, variations in the digital encoding of a program (e.g., in one part of a movie the ratio may be 8:1, but in another part the ratio may be 4:1, therefore complicating a calculation of the shift in program time during activation, deactivation, and/or reactivation of VCR control), and 2) when an interactive media system possesses latencies or other problems that prevent an accurate calculation of the shift in program time during activation, deactivation, and/or reactivation of VCR control.

For the end time method, some of the embodiments of this invention instantaneously calculates the effects of the VCR control actions on the end time of the program by executing a particular formula for each action. For pausing, the new end time equals the previous program end time of the program plus the duration that the pause is activated. For rewinding, the new end time equals the previous program end time plus the amount of program time rewound plus the duration that the rewind function is activated. For fast-forwarding, the new end time equals the previous program end time minus the amount of program time forwarded, plus the duration that the fast-forward function is activated. This method is used to calculate the remaining program time and similarly to calculate the remaining bookmark program time.

For the time stamp method, the Interactive Media Control Module 110 of the multimedia device 100 uses one or more exemplary algorithms based on the program duration (PD) provided by program information database 204, a multiplier (M) of the program duration that establishes the viewing time window (the multiplier could be (i) provided to the multimedia device 100 by head end 210, or (ii) hard coded on the multimedia device 100), a bookmark multiplier (BM) of the remaining program duration that establishes the bookmark viewing time window (similarly, the bookmark multiplier could be (i) provided to the multimedia device 100 by head end 210, or (ii) hard coded on the multimedia device 100), a time stamp (TS) that marks the time location in a program starting from the beginning of the program (the time stamp is delivered with the video data stream of the program), a bookmark time stamp (BTS) that marks a bookmark time location starting approximately from the remaining program time when the remaining viewing window is less than or equal to the remaining program time, and/or a counter that tracks each activation of the pause function and the rewind function during the viewing window and/or the bookmarked viewing window. Thus, during the showing of the program (including a bookmarked program), the Interactive Media Control Module 110 continually executes the following algorithms, where VTW is viewing time window, VT.sub.E is elapsed viewing time, VT.sub.R is remaining viewing time, PT.sub.R is remaining program time, PRT at DST is a cumulative elapsed VCR control time that accumulates during the viewing window from a beginning time of each use of the pause function or the rewind function until an ending time of each use of the pause function or the rewind function, SSFT is supplemental smart fixed time, BVTW is bookmarked viewing time window, BVT.sub.E is elapsed bookmarked viewing time, BVT.sub.R is remaining bookmarked viewing time, BPT.sub.R is remaining bookmarked program time, BPRT at BDST is a cumulative elapsed VCR control time that accumulates during a bookmarked viewing window from a beginning time of each use of the pause function or the rewind function until an ending time of each use of that particular pause function or that particular rewind function, and BSSFT is supplemental bookmarked smart fixed time:
PD−TS=PT.sub.R 1)
VTW−VT.sub.E=VT.sub.R 2)
SSFT=(PT.sub.R/PD)*(PRT at DST) 3)
If PT.sub.R.≧VT.sub.R+SSFT, then deactivate pause and rewind, insert BTS 4)
If PT.sub.R<VT.sub.R+SSFT, then activate pause and rewind 5)
BPD−BTS=BPT.sub.R 6)
BVTW−BVT.sub.E=BVT.sub.R 7)
BSSFT=(BPT.sub.R/BPD)*(BPRT at BDST) 8)
If BPT.sub.R.≧BVT.sub.R+BSSFT, then deactivate pause and rewind 9)
If BPT.sub.R<BVT.sub.R+BSSFT, then activate pause and rewind 10)

The multiplier M determines the duration of the viewing time window VTW relative to the program duration PD (i.e., PD.times.M=VTW) and the multiplier BS determines the BVTW relative to the bookmarked program duration BPD (i.e., PD.times.M=VTW). The value of multipliers M and BM depend largely on the individual needs and resources of the subscriber and on the service provider, including, for example, the capacity of video server 202, the size of communications network 220, the number and/or type of connected multimedia device 100, the projected number of subscriber orders during a given period, and the expectations of those subscribers in terms of an appropriate viewing time window, bookmarked viewing time window, and/or additional VCR control time (i.e., SSFT and BSSFT). Typically, a reasonable multiplier or bookmarked multiplier is from approximately 1.5 to 2. However, in an exemplary embodiment of this invention, multiplier M is 1.5 and bookmarked multiplier is 2, such that, for example, this invention would provide a 3 hour viewing time window for a 2 hour movie and a 2 hour bookmarked viewing window for a 1 hour bookmarked program duration of the movie.

### EXAMPLE

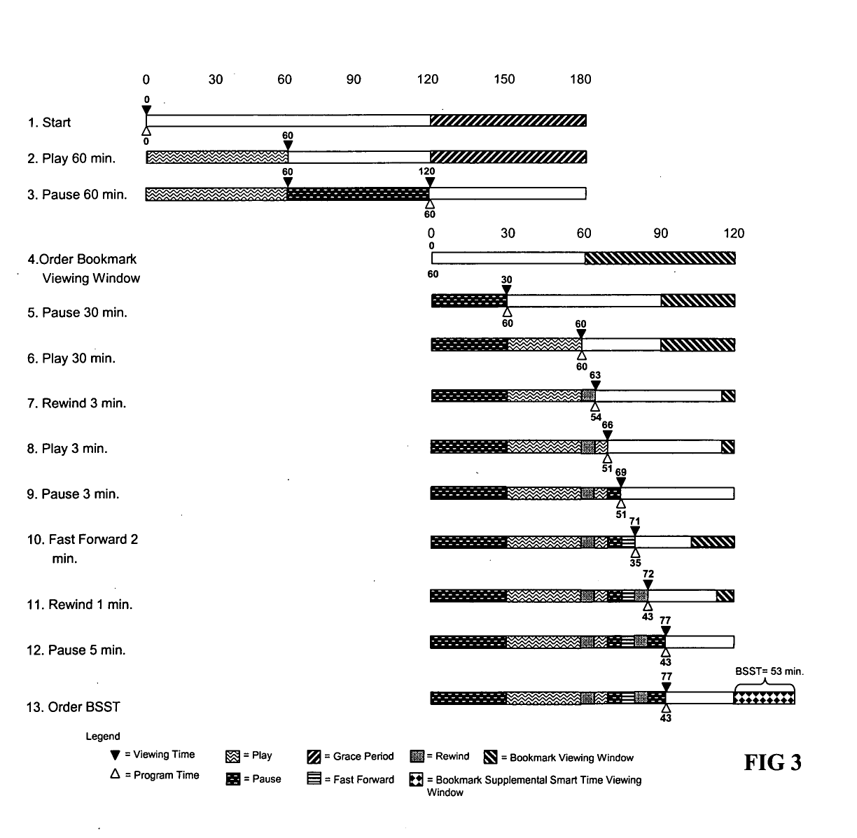

The following example illustrates how, according to exemplary embodiments, the effects of VCR control are tracked the VCR control is limited through the course of a program showing that includes an initial viewing window, a bookmarked viewing window, and an added on supplemental smart fixed time duration to reactivate VCR control of pause and rewind functions. FIG. 3 traces the playing of a 2 hour movie within a 3 hour viewing time window (with the multiplier M equal to 1.5), an 1 hour bookmarked duration of the movie within a 2 hour bookmarked viewing time window (with the multiplier BS=2), and a ten minute supplemental smart fixed time duration. The viewing time window is shown at the top of FIG. 2, spanning 0 to 180 minutes because the viewer has not yet ordered the bookmarked viewing window nor the supplemental smart fixed time duration. Under the viewing time window, the series of bars represents sequentially applied VCR commands. On each bar, the number above the bar next to the black triangle indicates the viewing time elapsed (VT.sub.E) in minutes or the bookmarked viewing time elapsed (BVT.sub.E) in minutes, while the number below the bar next to the white triangle indicates the time stamp (TS) or the bookmarked time stamp (BTS) in minutes of the movie. Each patterned region of the bars represents the duration a VCR command is applied. Finally, the patterned region at the end of the bars, between the heavy vertical line (representing the end of the movie) and the end of the bar, represents the time remaining for VCR control, which this application refers to as the grace period GP. This grace period GP depends on the viewing window, the bookmarked viewing window, and/or the supplemental smart fixed time duration. For example, the grace period, GP, equals VT.sub.R−PT.sub.R when the bookmarked viewing time is zero (i.e., the subscriber has not ordered the bookmarked viewing window) and when the supplemental smart fixed time duration is zero (e.g., the subscriber has not ordered additional time to reactivate VCR control or the supplemental time has expired)+BVT.sub.R−PT.sub.R.

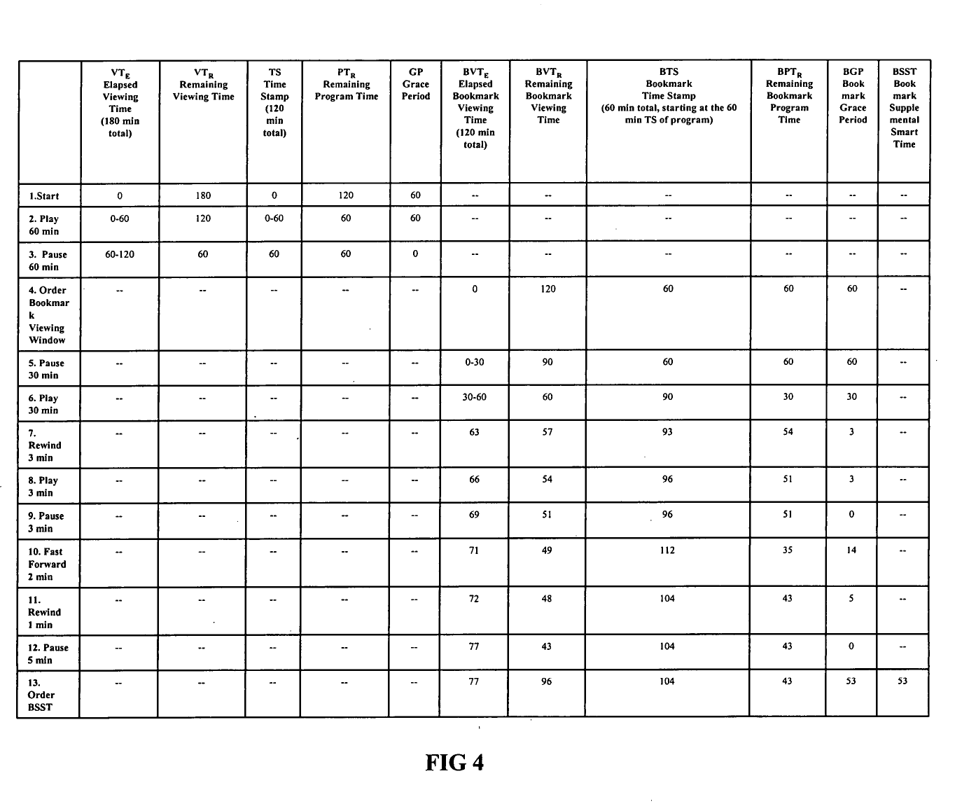

FIG. 4 is a table in which each row corresponds to each bar shown in FIG. 3. For each bar, the table lists the elapsed viewing time VT.sub.E, the remaining viewing time VT.sub.R, the program location or time stamp TS, the program time remaining PT.sub.R, the corresponding grace period GP, the elapsed bookmarked viewing time BVT.sub.E, the remaining bookmarked viewing time BVT.sub.R, the bookmarked program location or bookmark time stamp BTS, the bookmarked program time remaining BPT.sub.R, the corresponding grace period GP, and the supplemental smart fixed time duration to reactivate VCR control of pause and rewind.

The end time method instantaneously calculates the effects of the VCR control actions on the end time of the movie (including the end time of a bookmarked movie). For pausing, exemplary embodiments of this invention simply add the duration that the pause is activated to the previous end time of the program (including the remaining program time and the remaining bookmarked program time). For rewinding, exemplary embodiments of this invention add the amount of program time rewound plus the duration that the rewind function is activated to the previous program end time. For fast-forwarding, some of the embodiments of this invention subtract the amount of program time forwarded, minus the duration that the fast-forward function is activated, from the previous program end time. For interactive media systems that do not provide program time stamps, the end time method is the preferred method for calculating the remaining movie running time.

As an alternative to the end time method, the time stamp method calculates the remaining program running time by subtracting the time stamp of the program video stream from the total program duration and calculates the remaining bookmarked program running time by subtracting the bookmark time stamp of the bookmarked program video stream from the total bookmark program duration. For interactive media systems that do provide time stamps, the time stamp method is the preferred method for calculating the remaining program running time and the remaining bookmark program running time.

Referring to FIGS. 3 and 4, step 1 represents the point immediately after ordering of the movie, when the elapsed viewing time VT.sub.E and time stamp TS are equal to zero and the grace period is equal to 60 minutes. In step 2, the movie plays uninterrupted for 60 minutes, therefore having no effect on the grace period GP. At the end of step 2, both the elapsed viewing time VT.sub.E and time stamp TS are equal to 60 minutes. In addition, the algorithm yields VT.sub.R=VTW−VT.sub.E=180−60=120; PT.sub.R=PD−TS=120−60=60; and GP=VT.sub.R−PT.sub.R=120−60=60, where because PT.sub.R<VT.sub.R, the pause and rewind features are activated.

In step 3, the subscriber presses the pause feature for 60 minutes. During this period, the time stamp TS remains fixed at 60 minutes, while the elapsed viewing time VT.sub.E continues to 120 minutes. Because the time stamp TS did not progress, the subscriber consumed 60 minutes of the original 60 minutes of grace period GP during this pause period, leaving a grace period GP of 0 minutes. In reference to the algorithm, VT.sub.R=VTW−VT.sub.E=180−120=60; PT.sub.R=PD−TS=120−60=60; and GP=VT.sub.R−PT.sub.R=60−60=0. Since the remaining viewing time VT.sub.R is equal to or less than the remaining program time, the pause and rewind controls are deactivated, a bookmark is place at an elapsed time of 30 minutes into the program, and a post deactivation prompt is presented to the multimedia device 100 informing the viewer that pause and rewind have been deactivated because the remaining viewing time is equal to or less than the remaining program time. In this exemplary embodiment, the Interactive Media Control Module (shown as reference numeral 110 in FIGS. 1-2 and 5-6) prompts the user to order a bookmarked viewing window that provides another grace period so that VCR control of pause and rewind is restored for a limited duration (determined by bookmark multiplier BM). According to an alternate embodiment, the Interactive Media Control Module could present an alternate post deactivation prompt that offers the Supplemental Smart Fixed Time (SSFT) viewing window of an additional 30 minutes (calculated by (60/120)*(60)) and the SSFT could be added to the remaining viewing time, VT.sub.R.

Step 4 represents the point immediately after ordering of the bookmarked movie having a bookmarked duration of 60 minutes and a bookmarked viewing window of 120 minutes (that includes 60 minutes of the remaining viewing window) when the elapsed bookmark viewing time BVT.sub.E and bookmark time stamp BTS are equal to zero and the bookmarked grace period is equal to 60 minutes. In step 5, the subscriber activates the pause function for 30 minutes. During this period, the bookmark time stamp BTS remains at 0 minutes, while the elapsed bookmark viewing time BVT.sub.E continues to 30 minutes. Because the time stamp BTS did not progress, the subscriber consumed 30 minutes of the bookmarked grace period GP during this pause period, leaving a bookmarked grace period GP of 30 minutes. In reference to the algorithm, BVT.sub.R=120−30=90; BPT.sub.R=60−0=60; and BGP=BVT.sub.R−BPT.sub.R=90−60=30.

In step 6, the bookmarked movie plays uninterrupted for 30 minutes. At the end of this period, the bookmarked grace period BGP remains unchanged at 30 minutes, the elapsed bookmarked viewing time is 60 minutes, and the bookmark time stamp has advanced 30 minutes to 30 minutes from the starting bookmark in the program (e.g., from a bookmark time stamp when the remaining viewing time is equal to or less than the remaining program time) towards the end of the program. At this point, the algorithm calculates BVT.sub.R=BVTW−BVT.sub.E=120−60=60; BPT.sub.R=BPD−BTS=60−30=30; and BGP=BVT.sub.R−BPT.sub.R=60−30=30, where because BPT.sub.R<BVT.sub.R, the pause and rewind features are still activated.

In step 7, the subscriber now decides to return to a scene in the movie that occurred just after the 30 minute pause at the beginning of the bookmarked movie (e.g., to retrieve a bit of critical information). The subscriber therefore holds the rewind button down for 3 minutes and returns to a previous point in the movie. Assuming the customary 1:8 ratio of rewind time to program time, 3 minutes of rewind backs up the bookmark time stamp BTS of the bookmarked program 24 minutes, from 30 to 6. In addition, the subscriber spent 3 minutes of bookmarked viewing time to rewind to the previous scene, thereby advancing the elapsed bookmarked viewing time BVT.sub.E from 60 to 63 minutes. Therefore, the 24 minutes and 3 minutes are subtracted from the previous 30 minutes of bookmark grace period BGP to yield an updated, reduced bookmark grace period BGP of 3 minutes, where because BPT.sub.R<BVT.sub.R, the pause and rewind features are still activated.

In step 8, the subscriber releases the rewind button, plays the scene for 3 minutes, and views the missed plot information. Because the VCR control is not applied during this period, the remaining bookmarked viewing time BVT.sub.R and remaining bookmarked program time PT.sub.R advance concurrently and the bookmark grace period BGP stays at 3 minutes. The algorithm yields BVT.sub.R=BVTW−VT.sub.E=120−66=54; BPT.sub.R=BPD−BTS=60−9=51; and BGP=BVT.sub.R−BPT.sub.R=54−51=3, where because BPT.sub.R<BVT.sub.R, the pause and rewind features are still activated.

In step 9, the subscriber pauses the bookmarked program again for a short interruption (e.g., to get a drink). During this pause period, because the elapsed bookmarked viewing time BVT.sub.E continues and the bookmarked time stamp BTS is fixed, the time that the bookmarked program is paused is continually subtracted from the bookmarked grace period BGP of 3 minutes. Once paused for 3 minutes, the remaining bookmarked program time BPT.sub.R equals the remaining bookmarked viewing time BVT.sub.R, the bookmarked grace period BGP equals zero, and the Interactive Media Control Module 110 deactivates the pause and rewind functions. Thus, whether or not the subscriber is watching the program and releases the pause at 3 minutes, the Interactive Media Control Module 110 cancels the pause function and plays the bookmarked program. At the end of this 3 minute pause period, the algorithm shows BVT.sub.R=BVTW−BVT.sub.E=120−69=51; BPT.sub.R=BPD−BTS=60−9=51; and BGP=BVT.sub.R−BPT.sub.R=51−51=0, where because BPT.sub.R=BVT.sub.R, the pause and rewind features are deactivated.

Although the Interactive Media Control Module 110 would have deactivated the pause feature after 3 minutes, in step 10 the subscriber returns right at the 3 minute mark, releases the pause, and immediately fast-forwards to resume watching the bookmarked movie about 16 minutes ahead to avoid a frightening scene. The subscriber holds the fast-forward for 2 minutes and advances 16 minutes in the bookmarked program time (based on a 1:8 fast-forward ratio) to resume watching at the 25 minute bookmarked time stamp BTS. Advancing 16 minutes in time stamp, yet taking 2 minutes of viewing time to do so, yields a net gain in grace period BGP of 14 minutes. At this point, because BPT.sub.R<BVT.sub.R again, the Interactive Media Control Module 110 reactivates the pause and rewind features.

In step 11, after fast-forwarding the movie, the subscriber decides that she needs to rewind to obtain some critical plot information and rewinds for 1 minute and goes back 8 minutes in the bookmarked program time to resume watching at the 17 minute bookmarked time stamp BTS. In addition, the subscriber spent 1 minute of bookmarked viewing time to rewind to the previous scene, thereby advancing the elapsed bookmarked viewing time BVT.sub.E from 71 to 72 minutes. Therefore, the 8 minutes and 1 minute are subtracted from the previous 14 minutes of bookmark grace period BGP to yield an updated, reduced bookmark grace period BGP of 5 minutes, where because BPT.sub.R<BVT.sub.R, the pause and rewind features are still activated.

In step 12, the subscriber pauses the bookmarked program again for a short interruption (e.g., to answer a phone call). During this pause period, because the elapsed bookmarked viewing time BVT.sub.E continues and the bookmarked time stamp BTS is fixed, the time that the bookmarked program is paused is continually subtracted from the bookmarked grace period BGP of 5 minutes. Once paused for 5 minutes, the remaining bookmarked program time BPT.sub.R equals the remaining bookmarked viewing time BVT.sub.R, the bookmarked grace period BGP equals zero, and the Interactive Media Control Module 110 deactivates the pause and rewind functions. Thus, whether or not the subscriber is watching the program and releases the pause at 5 minutes, the Interactive Media Control Module 110 cancels the pause function. At this point, according to some of the further embodiments of this invention, the Interactive Media Control Module 110 may insert a deactivation bookmark at approximately the BTS and present a message to a display device of the multimedia device 100 that informs the subscriber that the pause and rewind function have been deactivated and that further presents a reactivation prompt to activate a supplemental smart fixed time duration to finish watching the bookmarked program with pause and rewind re-activated. In step 13, the Interactive Media Control Module 110 uses the BSST algorithm of BSSFT=(BPT.sub.R/BPD)*(BPRT at DST), that yields BSSFT=(43/60)*(30+(24+3)+3+(1+8)+5)=53 minutes. Consequently, if the subscriber uses the reactivation prompt to order the BSSFT, then 53 minutes is added to the remaining bookmarked viewing time, BVT.sub.R, such that the subscriber has 96 minutes to finish watching the remaining program. Alternatively, the Interactive Medial Control Module 110 may present a reactivation prompt that enables the viewer to override the supplemental smart fixed time duration and to enter an alternate duration for reactivating the pause rewind functions (e.g., ordering a just-in-time control for each subsequent re-activation of pause or rewind, ordering a duration selected by the user, and/or alternate methods for controlling reactivation).

In some of the alternate embodiments of this invention, the program source communicates a program and/or a bookmarked program to the multimedia device 100 containing at least two video portions. The video server orders and assembles the video portions into a playlist. For example, if the subscriber orders a movie and/or a bookmarked movie, this invention may precede the movie and/or the bookmarked movie with an advertisement, a movie trailer, and/or a public announcement. With distinct portions, exemplary embodiments of this invention can apply different VCR control to each portion. For example, during an advertisement video clip, this invention may provide rewind and pause, but not fast-forward to guarantee viewing for the advertisers. In addition, some of the embodiments of this invention may choose to include the duration of the preceding clips in the calculation of the viewing time window and the bookmarked viewing time window or exclude them to be more fair to the subscriber.

In any case, whether to provide full VCR control during preceding video clips or to include the duration of the preceding clips in the viewing time window and/or the bookmarked viewing time window depends largely on the individual needs and resources of the service provider and consideration of the subscriber.

The Interactive Media Control Module 110 not only governs the VCR control but also displays the status of available VCR control, subscriber messages, and other functional controls and prompts (e.g., deactivation prompt, reactivation prompt, post viewing time prompt, and others). Using graphics overlaid on the program video, the Interactive Media Control Module 110 provides visual indicators for bookmarked viewing time remaining, bookmark program time remaining, bookmarked grace period, supplemental smart fixed time for a viewing time window or for a bookmark viewing time window as well as corresponding grace periods that factor in the fixed time, post viewing time and post bookmarked viewing time information, and others.

For example, the Interactive Media Control Module 10 issues visual messages (text or icons) that inform the subscriber when the viewing time window (or, alternatively the bookmarked viewing time window) has expired (e.g., “Please note that the viewing time for the movie has ended and you may no longer access the movie or use VCR controls for the movie.,” and/or inform the subscriber when the viewing time window expires when the entire program has not been presented (e.g., “Please note that the viewing time for the movie ended and there are 40 minutes left in the movie, to order the remainder of the movie, please scroll to the ‘Order’ button below and press the ‘Enter’ key to activate another viewing time window to watch the remaining 40 minutes.) Still in further embodiments, the Interactive Media Control Module 110 displays the following types of information: 1) alerts the subscriber when rewind and pause are deactivated; 2) when rewind and pause are deactivated, presents a reactivation prompt to reactivate the rewind and pause function by ordering either a bookmarked program, a supplemental smart fixed duration to a viewing window, a bookmarked supplemental smart fixed duration to a bookmarked viewing window, or, alternatively, on an as needed or as commanded basis (e.g., if the grace period is zero and the subscriber wishes to pause the program, the subscriber presses the ‘Pause’ key, is informed that pause is deactivated, and is prompted to purchase a fixed amount of time to pause the movie, the rates the service provider charges for the as needed supplemental time may be set at a higher rate to adjust the bandwidth requirements and to make the subscriber more selective about how a program or bookmarked program is initially order (e.g., in selecting a higher or lower multiplier), 3) alerts the subscriber when rewind and pause are re-activated; 4) warns the subscriber a designated time before rewind and pause time expire; 5) provides a visual indication of the remaining pause and rewind time; 6) provides a visual indication of the time remaining in the viewing window when supplemental time is order, the time remaining in the bookmarked viewing window, and the time remaining in the bookmarked program when bookmarked supplemental time is ordered; and 7) provides post viewing time information to inform the subscriber that the viewing time window is expires, the program is no longer accessible, VCR controls are disabled, viewing statistics (e.g., duration of used viewing window, duration of default viewing window, statistics of VCR controls—activating fast forward, rewind, and pause, bookmark in program when the remaining viewing time window is equal to or less than the remaining program time, a post viewing time bookmark in the program if the viewing window expired with unpresented program, and others), and prompts to activate additional purchases, such as to order a bookmarked viewing window to finish watching an unfinished movie at a bookmarked location.

The display of the Interactive Media Control Module 110 can be any number of graphical overlays, depending on the particular network resources (e.g., graphical user interfaces) of a service provider and system components including software of the display device of the multimedia device 100. For example, the display can be a pop-up window listing the relevant time information or perhaps a small bar graph, similar to the bars illustrated in FIG. 3, that is continually displayed in the corner of the screen. For the bar graph, as the subscriber watches the program and/or the bookmarked program and presses VCR commands, the program time bar (or the bookmarked time bar) shifts within the viewing time window (or the bookmarked viewing time window) and shows the current remaining grace period. If the program time bar shifts all the way to the right, the subscriber recognizes that there is no grace period and that pause and rewind are accordingly deactivated.

Alternatively, the display could be a graphical bar chart indicating the amount of rewind and pause time remaining. As each VCR control function is activated, the bar chart would change to indicate the time remaining.

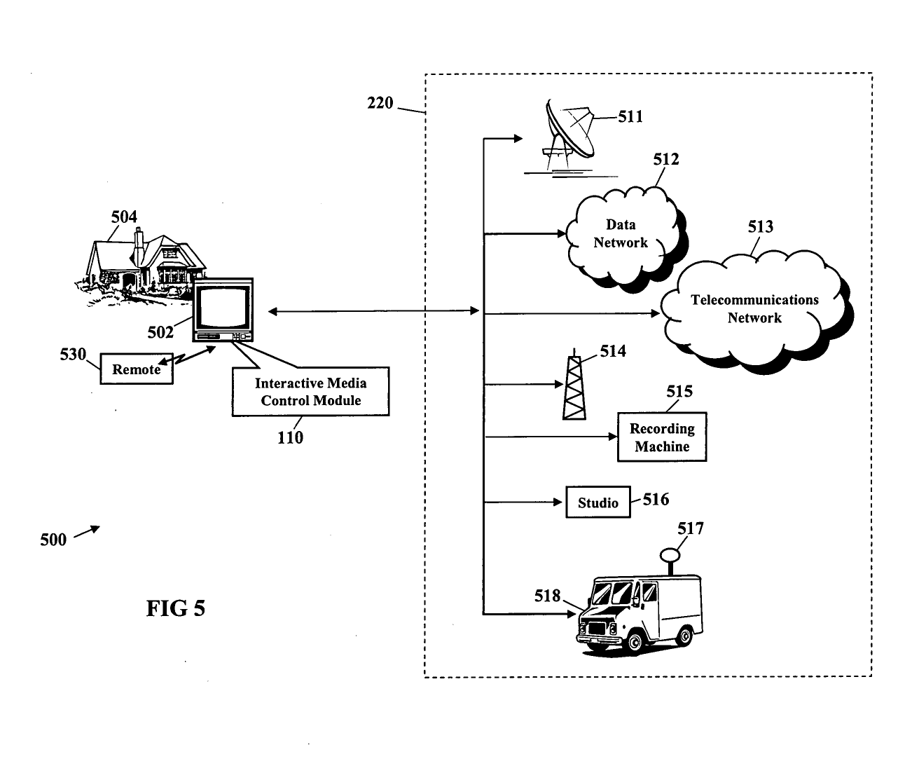

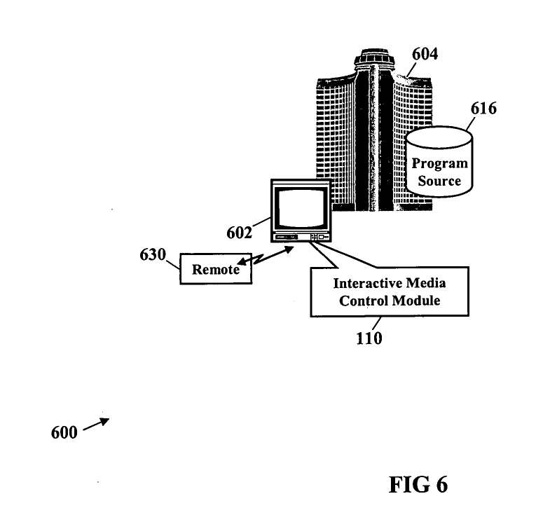

FIG. 5 depicts another exemplary embodiment of an interactive media control system 500. The interactive media control system 500 illustrates a residence 504 with a multimedia device shown as an integrated set top box and television 502 having the Interactive Media Control Module 110, a remote control device 530, and at least one communications network 220. Alternatively, the residence 504 may be depicted as a business, such as a hotel that provides a video-on-demand service to each of the hotel rooms (see FIG. 6). The multimedia device 502 receives graphics, audio and other forms of a program (or, a portion of program—e.g., a portion of a program from a bookmark in a program to an ending time in the program) from one or more communications networks that include a variety of broadcasts and communication mediums. As shown in FIG. 5, these broadcast systems may include a direct digital broadcast via satellite TV 511, a communication link with a data communications network 512, a communications link with a telecommunication network 513, a broadcast via digital cable TV 514, and/or a terrestrial broadcast analog and/or digital TV such as a broadcast from a recording device 515, a studio 516, or a mobile vehicle 518 with an antenna and receiver 517. Further, the Interactive Media Control Module 110 may interact with a directory-on-demand service (or an alternate source that provides the program) via a web browser or alternate interface to present a menu to a display device of the multimedia device 502. If the Interactive Media Control Module 110 uses the web browser, then an application server may respond to Hyper-Text Transfer Protocol (HTTP) requests by processing the requested URL and parameters according to the services it is providing. This may require accessing and/or storing data (e.g., the electronics communications directory) in a server database. According to an exemplary embodiment, the directory-on-demand service stores the electronics communications directory and related information as Extensible Style Sheet (XSL) documents that allow the XML directory-on-demand information to be translated into HTML using an XSL processor. The server application (within the communications network) then translates the XML data into HTML data and transmits it to the web browser that presents the HTML data of the electronics communications directory to the display device, such as a computer monitor or a television screen. The information presented, for example, may include information about ordering the program, ordering the bookmarked program, ordering additional time to re-activate VCR-controls, status information, billing information, a history of viewing times, bookmarked viewing times, and/or supplemental re-activation time that was ordered with other program, communications connections and selections (e.g., ordering the program to be delivered to a non-networked set-top box having a different communications address, such as a fiend ordering a program with viewing windows, optional bookmark viewing windows, and/or supplemental re-activation time to be communicated to another set-top box (or alternate multimedia device, such as a cellular phone) of a friend), and/or other related information that is available via the directory-on-demand service. According to another exemplary embodiment, Real Simple Syndication (RSS) that uses XML structures may be similarly used to feed the program and related information from a source (e.g., a directory-on-demand service provider in the communications network, a local directory networked to the multimedia device, and others) to a destination (e.g., the multimedia device).

FIG. 6 depicts yet another exemplary embodiment of an interactive media control system 600. Here, the interactive media control system 600 illustrates a business 604 with a multimedia device shown as an integrated set top box and television 602 having the Interactive Media Control Module 110, a remote control device 630, and a local program source 616 (e.g., a dataserver that accesses, selects, stores, and communicates programs). The multimedia device 602 receives graphics, audio and other forms of a program (or, a portion of program—e.g., a portion of a program from a bookmark in a program to an ending time in the program) from the program source 616.

Similar to above, the user initiates an interactive media control session to the multimedia device 602 by interfacing with the Interactive Media Control Module 110 by actuating a pushbutton of the remote control device 630, by voice commands, and/or by other selection methods. According to some of the embodiments, the Interactive Media Control Module 110 presents a graphical user interface that enables a broad range of functionality for ordering, distributing, and/or otherwise managing the program, the bookmarked program, and/or supplemental re-activation time of the program. For example, an infrared remote control, an input terminal, and/or an optional wireless keyboard can communicate with the multimedia device 602 to interact with the graphical user interface that is presented on an audio/visual device such as a TV screen.

The Interactive Media Control Module (shown as reference numeral 110 in FIGS. 1-2 and 5-6) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of this invention, allow the Interactive Media Control Module to be easily disseminated.

Still in further exemplary embodiments, the Interactive Media Control Module may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol phone, and/or a wireless pager (some of these exemplary embodiments are shown in FIG. 2).

The foregoing disclosure of embodiments of this invention has been presented for purposes of illustration and description. It is not intended to be exhaustive or to limit the invention to the precise forms disclosed. The following description of the system architecture and the methods for implementing within that architecture are examples of this invention. Although this invention is applicable to a variety of services in which networked media delivery systems deliver purchased programs to subscribers, the following description and schematics trace the operation of this invention in the context of a video-on-demand system. While the method described herein and illustrated in the figures contains many specific examples of media flow steps, these steps should not be construed as limitations on the scope of the invention, but rather as examples of media flow steps that could be used to practice the invention. As would be apparent to one of ordinary skill in the art, many other variations on the system operation are possible, including differently grouped and ordered method steps. Accordingly, the scope of the invention should be determined not by the embodiments illustrated, but by the appended claims and their equivalents.

What is claimed is:

1. A method for providing media delivery control of an interactive media system comprising:
bookmarking a program with a bookmark when a remaining viewing time window equals or is less than a remaining program time of the program;
calculating a bookmarked program time of a program from a bookmarked time to an ending time of the program;
establishing a bookmarked viewing time window during which a program must be watched, the bookmarked viewing time window equal to or greater than the bookmarked program time;
playing the program from approximately the bookmark and providing a pause function and a rewind function;
calculating a remaining bookmarked viewing time of the bookmarked viewing time window and a remaining bookmarked program time; and
activating the pause function and the rewind function if the remaining bookmarked program time is less than the remaining bookmarked viewing time.

2. The method of claim 1, further comprising:
deactivating the pause function and the rewind function if the remaining bookmarked program time is equal to or greater than the remaining bookmarked viewing time.

3. The method of claim 1, wherein establishing the bookmarked viewing time window comprises multiplying a duration of the bookmarked program time by a multiplier.

4. The method of claim 1, wherein calculating the remaining bookmarked viewing time comprises:
counting an elapsed bookmarked viewing time from the bookmark; and
subtracting the elapsed bookmarked viewing time from the bookmarked viewing time window.

5. The method of claim 1, wherein calculating the remaining bookmarked program time comprises:
receiving a bookmark time stamp of the bookmarked time;
receiving a duration of the program;
subtracting the bookmark time stamp from the program duration to calculate a bookmark duration time;
receiving a subsequent time stamp encoded in the program; and
subtracting the subsequent time stamp from the bookmark duration time.

6. The method of claim 1, wherein calculating the remaining bookmarked program time comprises:
receiving a bookmark duration time of the program from the bookmarked time to the ending time of the program;
if the pause function is activated for a pause duration, adding the pause duration to the bookmark duration time; and
if the rewind function is activated for a rewind duration, which shifts the program back a rewound program time, adding the rewind duration and the rewound program time to the bookmark duration time.

7. The method of claim 8, further comprising:
providing a fast-forward function; and
if the fast-forward function is activated for a fast-forward duration, which shifts the program forward a fast-forward bookmarked program time, subtracting the fast-forward bookmarked program time from and adding the fast-forward duration to the bookmarked duration time.

8. The method of claim 7, wherein a rewound bookmarked program time and a fast-forwarded bookmarked program time are a proportion of the rewind duration and the fast-forward duration, respectively.

9. The method of claim 1, further comprising:
displaying a status to the interactive media system.

10. The method of claim 9, wherein the status comprises the remaining bookmarked viewing time and the remaining bookmarked program time.

11. The method of claim 9, further comprising:
calculating a bookmarked grace period; and
displaying the status, wherein the status comprises the bookmarked grace period.

12. The method of claim 11, wherein calculating the bookmarked grace period comprises subtracting the remaining bookmarked program time from the remaining bookmarked viewing time.

13. The method of claim 9, wherein displaying a status comprises inserting a graphic presentation of the status with the program.

14. The method of claim 9, further comprising:
calculating a remaining bookmarked pause and rewind function time; and
displaying the status, wherein the status comprises the remaining bookmarked pause and rewind function time.

15. The method of claim 1, wherein the program comprises a first portion and a second portion, and wherein the bookmarked viewing time window is calculated based on the second portion only.

16. The method of claim 1, wherein the program comprises a first portion and a second portion and wherein the pause function and the rewind function are only provided during the second portion.

17. The method of claim 1, wherein bookmarking the program comprises encoding the bookmark in the program at a time stamp when the viewing time window equals or is less than the remaining program time.

18. The method of claim 1, wherein bookmarking the program comprises encoding the bookmark in the program prior to a time stamp when the viewing time window equals or is less than a remaining program time.

19. A method for providing media delivery control of an interactive media system comprising:
ordering a bookmarked viewing time via the interactive media system, the bookmarked viewing time comprising at least a bookmarked time of a program to an ending time of the program, the bookmarked time established when a remaining viewing time window equals or is less than a remaining program time of the program, such that the pause function and the rewind function are activated if a remaining bookmarked program time is less than a remaining bookmarked viewing time.

20. An interactive media device comprising:
at least one processing device communicating with a program source to receive a program, wherein the at least one processing device calculates a bookmarked viewing time window within which to transmit a portion of the program from a bookmark in the program to an end of the program, calculates a remaining bookmarked viewing time of the bookmarked viewing time window, calculates a remaining bookmarked program time of the program, and provides a pause function and a rewind function when the remaining bookmarked viewing time is greater than the remaining bookmarked program time.

21. The device of claim 20, further comprising an input device, in communication with the at least one processing device, for activating the pause function and the rewind function.

22. The device of claim 20, wherein the at least one processing device provides a fast-forward function, a stop function, a scene jump function, a status function, a post viewing time status function, and a bookmarked reactivation function.

23. The device of claim 20, wherein the at least one processing device comprises an operating system, an interactive media control module provisioned on the operating system, and a memory storage.

24. The device of claim 20, wherein the at least one processing device comprises one of a set top box and a computer.

25. An interactive media system for media delivery control, the system comprising:
a program database in communication with a video server, the program database storing the program and a duration of the program;
the video server for accessing and communicating the program; and
at least one processing device in communication with the video server, wherein the at least one processing device calculates a bookmarked viewing time window within which to transmit a portion of the program from a bookmark in the program to an end of the program, calculates a remaining bookmarked viewing time of the bookmarked viewing time window, calculates a remaining bookmarked program time of the program, and provides a pause function and a rewind function when the remaining bookmarked viewing time is greater than the remaining bookmarked program time.

26. The system of claim 25, further comprising a distribution network over which the video server communicates with the at least one processing device.

27. A method for re-activating limited interactive media video cassette recorder (VCR) control comprising re-activating VCR functions for a fixed bookmarked duration when a remaining program duration equals or exceeds a remaining viewing time window.

28. A multimedia device that re-activates interactive media video cassette recorder (VCR) control, comprising:
a receiver that receives a program, a program duration, a bookmark time stamp, a first program time stamp, and a second program time stamp from a program source;
a transmitter that communicates VCR functions to the program source; and
an application that counts elapsed viewing time, subtracts the elapsed viewing time from the fixed program duration to determine a remaining viewing time, subtracts the first program time stamp from the program duration to determine a remaining program duration, encodes the bookmark time stamp when the remaining program duration equals the remaining viewing time, counts elapsed bookmarked viewing time, subtracts the elapsed bookmarked viewing time from a remaining fixed program duration to determine a remaining bookmarked viewing time, subtracts the second program time stamp from the remaining program duration to determine a remaining bookmarked program duration, and stops the transmitter from sending the VCR functions when the remaining bookmarked program duration equals or exceeds the remaining bookmarked viewing time.

29. A method for providing video cassette recorder control of an interactive media system comprising:
establishing a viewing time window during which a program must be watched;
playing the program and providing a pause function and a rewind function;
calculating a remaining viewing time of the viewing time window and a remaining program time of the program;
activating the pause function and the rewind function if the remaining program time is less than the remaining viewing time;
deactivating the pause function and the rewind function if the remaining program time is equal to or greater than the remaining viewing time; and
displaying a post viewing time status comprising an end time of the viewing time window and a notification that viewing time window has expired such that further viewing of the program is not available.
